(19) United States
(12) Patent Application Publication
(10) Pub. No.: US 2017/0103508 A1
(43) Pub. Date: Apr. 13, 2017

(54) IMAGING SYSTEM FOR AN AUTOMATED PRODUCTION LINE

(71) Applicant: FORD GLOBAL TECHNOLOGIES, LLC, Dearborn, MI (US)

(72) Inventors: Tsunou CHANG, Billericay (GB); Jonathan Richard BISHOP, Loughton (GB)

(73) Assignee: FORD GLOBAL TECHNOLOGIES, LLC, Dearborn, MI (US)

(21) Appl. No.: 15/286,884

(22) Filed: Oct. 6, 2016

(30) Foreign Application Priority Data
Oct. 7, 2015 (GB) 1517718.1
Oct. 7, 2015 (IN) 5367/CHE/2015

(51) Int. Cl. G06T 7/00; H04N 5/247

(52) U.S. Cl. CPC G06T 7/001; H04N 5/247; G06T 2207/30164

(57) ABSTRACT

An imaging system for an automated production line comprising: a primary imaging device configured to capture an image of an item on the automated production line and compare the image of the item to one or more verification images stored in a database; a secondary imaging device configured to capture one or more of the verification images and update the database in parallel with the operation of the primary imaging device while the automated assembly line is in operation.

### CROSS-REFERENCE TO RELATED APPLICATIONS

This application claims foreign priority benefits under 35 U.S.C. §119(a)-(d) to GB 1517718.1 filed Oct. 7, 2015 and IN 5367/CHE/2015 filed Oct. 7, 2015, disclosures of which are hereby incorporated by reference in their entirety.

### TECHNICAL FIELD

This disclosure relates to an imaging system for an automated production line having a primary imaging device and a secondary imaging device.

### BACKGROUND

An automated production line can be used during the manufacture and assembly of components. Typically, automotive manufacturers use automated processes on a production line to assemble various components of an automobile. For example, the automated process may involve applying a sealant to a first portion of an engine casing before assembling it to a second portion of the engine casing.

The type of automated process depends on the purpose of the automated station of the production line at which a component arrives. As such, a particular station of the automated production line is usually programmed to perform a particular manufacturing or assembly operation, such as applying the sealant in the required manner to the first engine casing portion.

A problem that the automotive manufacture faces is that the automated production line is used for a variety of different versions of a component, each of which may have a different configuration and/or different assembly requirements. It is desirable, therefore, for any particular station of the assembly line to be able to adapt its programming depending on the configuration of the component. For example, when an automotive manufacture introduces a change to the configuration of a component and/or the requirements of an assembly process, it is desirable to minimize the downtime of the automated production line while it is reconfigured to accept a new version of the component and/or perform a new assembly process.

### SUMMARY

According to an aspect of the present disclosure there is provided an imaging system for an automated production line. The imaging system may include a primary imaging device configured to capture an image of an item on the automated production line. For example, the primary imaging device may be positioned such that it can capture one or more images of the item when the item is on the automated production line. The imaging system is configured to compare the image of the item to one or more verification images stored in a database. For example, the primary imaging device may include a controller configured to perform analysis on the captured image and/or the verification image. The one or more captured images may be used to identify the item and/or to check the quality of one or more operations carried out by the automated production line.

The imaging system may include a secondary imaging device configured to capture one or more of the verification images. The secondary imaging device is configured to update the database in parallel with, for example at the same time as, the operation of the primary imaging device while the automated assembly line is in operation. In this manner, the primary imaging device need not be taken offline whenever the database is updated with new verification data, such as data regarding a new item to be processed by the automated production line and/or changes to the requirements of an existing production process.

The secondary imaging device may be remote from the automated production line, such that the verification images may be captured at a location different from the automated production line. The secondary imaging device may be remote from the primary imaging device, such that the verification images may be captured at a location different from the primary imaging device. In this manner, the verification images of a component may be captured as the component is manufactured, for example at a different manufacturing facility to where the automated production line and/or the primary imaging device is located.

The secondary imaging device may be provided at a point on the automated production line. For example, the secondary imaging device may be provided at a point on the automated production line that is upstream of the primary imaging device, so that the database of verification images may be updated before the item arrives at the primary imaging device. The secondary imaging device may be configured to capture the verification image of the item while the item is on the automated production line.

The first imaging device may be configured to capture a first image, e.g. an identification image, of the item on the automated production line before the automated production line performs an operation on the item. The first imaging device may be configured to capture a second image, e.g. a quality check image, of the item on the automated production line after the automated production line has performed an operation on the item. The first imaging device may include a first camera and a second camera. The first camera may be configured to capture the first image the item and/or the second image of the item. The second camera may be configured to capture the first image the item and/or the second image. The first and/or second cameras may each be moveable between positions, such that they can capture images of the item at various stages of production. For example, the first and/or second cameras may each be configured to capture the identification image and/or the quality check image.

There may be provided an automated production line including one or more of the above described imaging systems.

According to another aspect of the present disclosure there is provided a method of operating an imaging system for an automated production line. The method includes capturing an image of an item on the automated production line using a primary imaging device. The method includes comparing the image of the item to a verification image stored in a database. The method includes capturing one or more of the verification images using a secondary imaging device. The method further includes updating the database in parallel with the operation of the first imaging device while the automated assembly line is in operation.

According to another aspect of the present disclosure, an automated production line imaging system is provided. The imaging system includes a production line imaging device configured to capture at least one image of a item on the automated production line. The imaging system includes a verification imaging device configured to capture at least one image of a second item to be fed into the automated production line. The imaging system includes a controller operatively connected to the first imaging device and the second imaging device. The controller is configured to store a database of verification images. The controller is configured to analyze, for example compare, the captured image of the item to at least one verification image stored in the database. The controller is configured to update the database with the verification image of the second item in parallel with the operation of the first imaging device, such that the first imaging device remains operational on the automated production line.

The disclosure also provides software, such as a computer program or a computer program product for carrying out any of the methods described herein, and a computer readable medium having stored thereon a program for carrying out any of the methods described herein. A computer program embodying the disclosure may be stored on a computer-readable medium, or it could, for example, be in the form of a signal such as a downloadable data signal provided from an Internet website, or it could be in any other form.

To avoid unnecessary duplication of effort and repetition of text in the specification, certain features are described in relation to only one or several aspects or arrangements of the disclosure. However, it is to be understood that, where it is technically possible, features described in relation to any aspect or arrangement of the disclosure may also be used with any other aspect or arrangement of the disclosure.

### BRIEF DESCRIPTION OF THE DRAWINGS

For a better understanding of the present disclosure, and to show more clearly how it may be carried into effect, reference will now be made, by way of example, to the accompanying drawings, in which:

FIG. 1 shows a schematic representation of an imaging system for an automated production line;

FIG. 2 shows a schematic representation of another imaging system for an automated production line;

FIG. 3 shows a schematic representation of a further imaging system for an automated production line;

FIG. 4 shows a flowchart that depicts a mode of operation of the imaging system;

FIG. 5 shows a portion of an engine casing; and

FIG. 6 shows a flowchart that depicts another mode of operation of the imaging system.

### DETAILED DESCRIPTION

As required, detailed embodiments of the present invention are disclosed herein; however, it is to be understood that the disclosed embodiments are merely exemplary of the invention that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

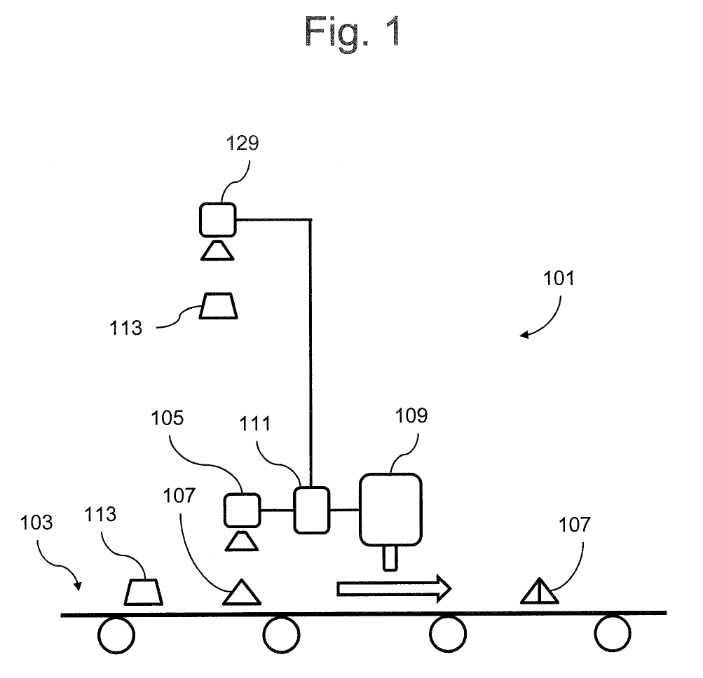

FIGS. 1, 2 and 3 show arrangements of an imaging system 101 for an automated production line 103. The automated production line 103 may be configured to perform any appropriate type of operation on any appropriate component. For example, the automated production line 103 may be used during the manufacture and assembly of an engine for a vehicle. The imaging system 101 includes a primary imaging device 105 that is configured to capture an image of an item 107, 113 on the production line 103. As such, the item 107, 113 on the automated production line 103 may be an engine casing portion, for example a crank casing, a cylinder block or a cylinder head.

The automated production line 103 may include one or more automated production stations 109 configured to perform an operation on the item 107, 113. For example, the station 109 may be configured to perform an assembly operation where a sealant is applied to a sealing face of the engine casing, and/or where the engine casing portion is assembled with one or more other components. Additionally or alternatively, the station 109 may be configured to perform a machining operation on the engine casing portion, such as machining an opening for a fastener.

In the arrangement shown in FIG. 1, the imaging system 101 is used for the purposes of identifying an item on the automated production line 103. For example, the automated production station 109 may be configured to perform respective operations on the item 107 and the item 113 in succession. As a result, it is necessary to identify the type of item that approaches the automated production station 109 such that the station 109 can perform the correct operation on each of the items 107, 113.

The imaging device 105 is positioned upstream of the automated production station 109 and is configured to capture an image of each item 107, 113 as it approaches the automated production station 109, i.e. before the automated production station 109 performs an operation on the item 107, 113. The imaging device 105 is operatively connected to the database 111 of verification images such that the imaging device 105 can compare the captured image of the item 107, 113 with one or more verification images stored in the database 111. In this manner, the imaging device 105 is able to determine the identity and/or configuration of the item 107, 113 that approaches the automated production station 109, so that the production station 109 can adjust its programming accordingly.

For example, the first item 107 may be a first type of ladderframe casing for an engine type and the second item 113 may be a second type of ladderframe casing for the engine type. As such, it is necessary to identify which type of ladderframe casing is approaching the automated production station 109 so that the correct operation is performed, as required by the configuration of the ladderframe casings. Once the imaging device 105 has captured the image, it can be cross-referenced against a library of images stored in the database 111 so that the production station 109 can modify its set-up accordingly.

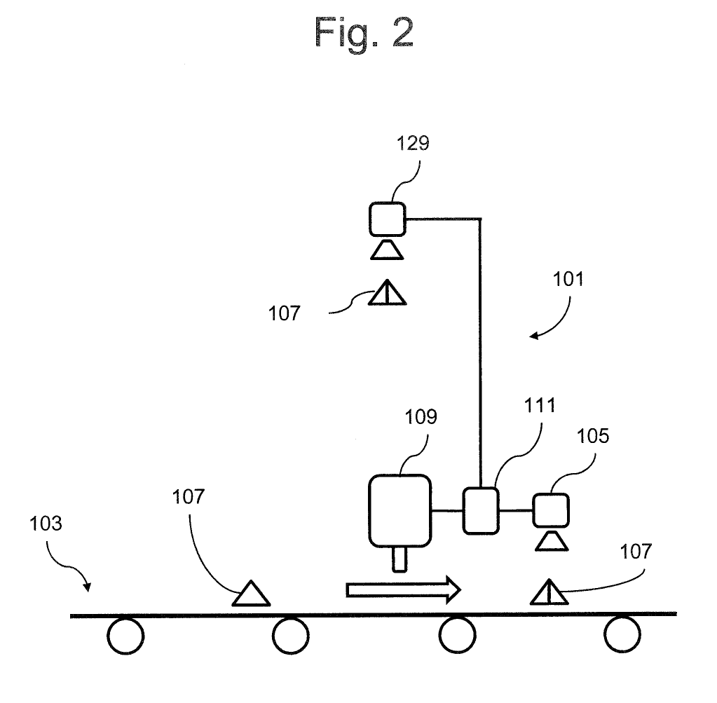

In another arrangement, shown in FIG. 2, the imaging system 101 is configured to verify that automated production station 109 has performed an operation in a required manner. For example, the automated production station 109 may be configured to perform a machining operation on the item 107 and/or an assembly operation on the part 107. As a result, it is necessary to verify the accuracy of operation performed by the automated production station 109.

The imaging device 105 is positioned downstream of the automated production station 109 and is configured to capture an image of each item 107 as it leaves the automated production station 109, i.e., after the automated production station 109 has performed an operation on the item 107. The imaging device 105 is operatively connected to a database 111 of verification images such that the imaging device 105 can compare the captured image of the item 107 with one or more verification images stored in the database 111. In this manner, the imaging device 105 is able to determine the accuracy of the operation that has been performed on the item 107, or indeed if the operation has been performed at all. In this manner, imaging system 101 is configured to determine whether or not the item 107 is suitable for use.

For example, the automated production station 109 may be configured to apply a bead of sealant to a sealing face of a ladderframe casing of an engine before bringing the sealing face of the ladderframe into engagement with a corresponding sealing face of another component. In order to ensure that a reliable seal is formed between the two sealing faces, the sealant must be applied in a prescribed manner. As such, it is necessary to determine the accuracy with which the sealant has been applied to the sealing face, e.g. if the location of the sealant on the sealing face is within tolerance.

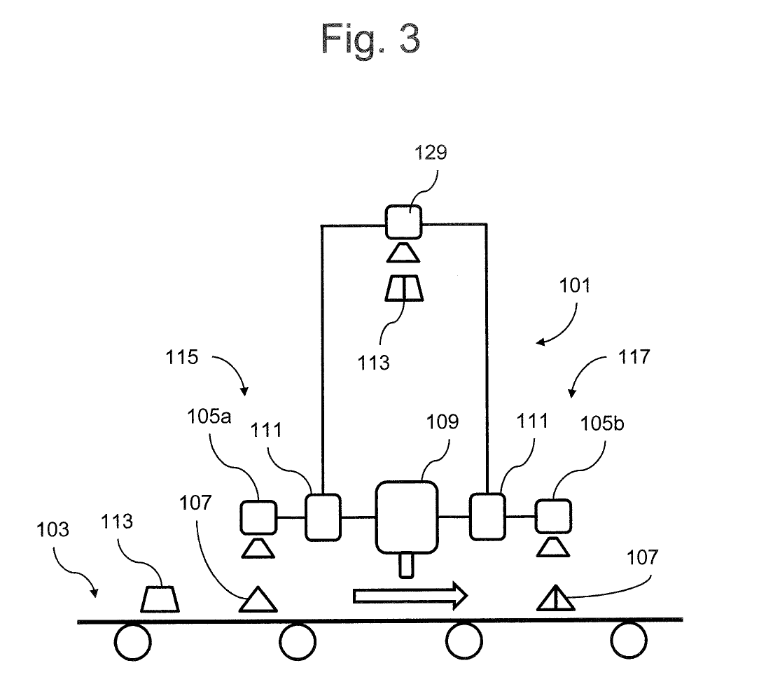

In another arrangement shown in FIG. 3, the imaging system 101 is configured to identify the items 107, 113 on the automated production line 103 and verify that automated production station 109 has performed an operation on each of the items 107, 113 in a required manner. In other words, the imaging system 101 shown in FIG. 3 is a combination of the arrangements shown in FIGS. 1 and 2, with the benefits of each of the above described arrangements applying equally to the arrangement of FIG. 3.

In the arrangement shown in FIG. 3, the imaging system 101 includes a first primary imaging device 105a and a second primary imaging device 105b. The first primary imaging device 105a is positioned upstream of the automated production station 109 and is configured to capture an image of each item 107, 113 as it approaches the automated production station 109, i.e., before the automated production station 109 performs an operation on the item 107, 113. The second primary imaging device 105b is positioned downstream of the automated production station 109 and is configured to capture an image of each item 107, 113 as it leaves the automated production station 109, i.e., after the automated production station 109 has performed an operation on the item 107, 113. It is understood, however, that in such a combined system, the primary imaging device may include a single imaging device 105, for example an imaging device that is movable between the position 115 upstream of the automated production station 109 and the position 117 downstream of the automated production station 109. While it is appreciated that it may take several seconds to move the primary imaging device between the positions 115, 117, the time taken to complete the operation on the item 107, 113 may be greater than the time taken to move the imaging device 105.

One of the challenges in operating the automated production line 103 is maximising its overall output. One way of achieving this is to use the automated production line 103 to perform a plurality of different operations on a plurality of differently configured items, as described above. However, in order to introduce a new type of item into the production line 103 and/or configure the automated production station 109 to perform a new type of operation on the item, the automated production line 103, or at least the imaging system 101, is typically taken offline in order to update the database 111 of verification images that are used to identify the items and/or check the accuracy of the automated process. It is desirable, therefore, to minimise the downtime of the production line 103 so as to maximise its overall output.

Where an automotive manufacturer introduces a new product to a range, the database 111 of verification images must be updated to include images of the new product. In a similar manner, where an automotive manufacturer introduces a design change to an existing product, such as moving the location of a fastener and/or changing the requirements for the application of a sealant to a component, the database 111 of verification images must be updated to include the new location of the fastener on the component and/or an image exemplifying the new requirements for the application of the sealant.

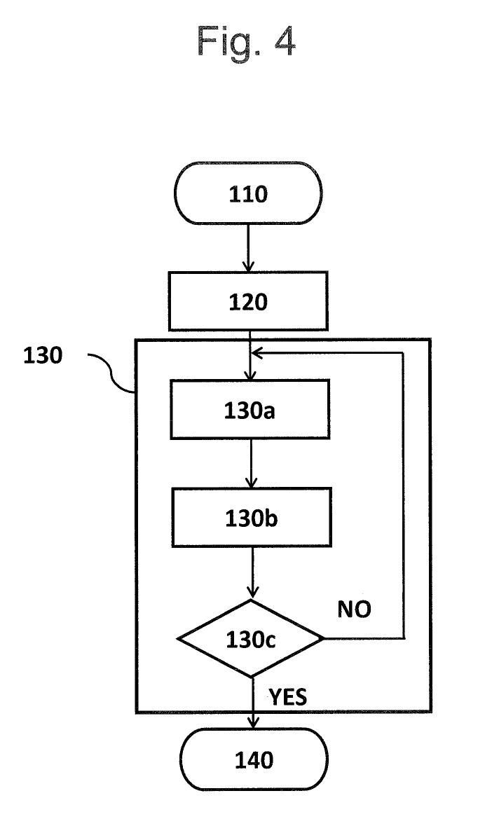

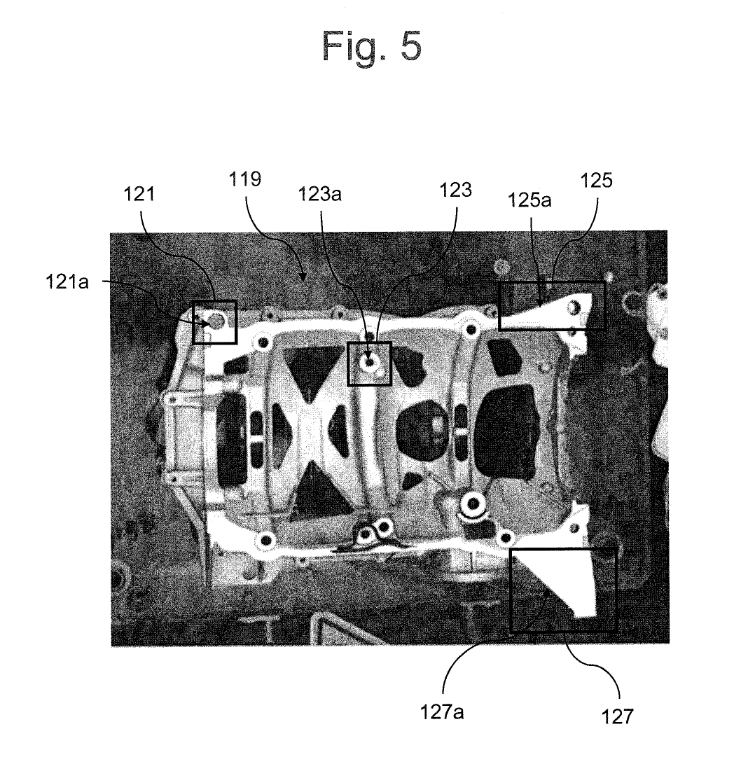

FIG. 4 shows a flow chart depicting an operational mode of the imaging system 101 in which an image, as shown in FIG. 5, is used to identify a component on the production line. The operational mode of the imaging system 101 will now be described with reference to the arrangement shown in FIG. 1. However, the imaging system 101 may be used in a similar manner for the arrangements shown in FIGS. 2 and 3, and/or any other appropriate arrangement.

At step 110, the item 107 approaches the automated production station 109. Since the imaging device 105 is configured to capture an image of the item 107 on the automated production line 103, the imaging device 105 may be used to identify the type and/or configuration of the item 107 before the production station 109 performs an operation.

At step 120 the imaging device 105 captures an image of the item 107. FIG. 5 shows an image of a ladderframe casing 119 for an engine captured by the imaging device 105. The ladderframe 119 has a multitude of features that may be used to identify the component. However, in the example mode described herein, four separate features of the ladderframe casing 119 are used, in combination, to differentiate the ladderframe casing 119 from a similarly configured ladderframe casing (not shown).

At step 130, the imaging device 105 compares the image of the item 107 to one or more verification images stored in the database 111. Depending on the configuration of the item 107, the imaging device 105 may be configured to analyze the image of the item 107 in any appropriate manner. In the example shown in FIG. 5, the imaging device 105 is configured to analyze four discrete areas 121, 123, 125, 127 of the image, and compare those areas to corresponding areas of the verification image. However, the imaging device 105 may be configured to analyze any appropriate portion of the image, or indeed the image as a whole, in order to determine the configuration of the item 107.

In the operational mode depicted in FIG. 4, the comparison step 130 comprises three separate steps 130a, 130b, 130c. However, the comparison step 130 may comprise any appropriate number of steps and may be conducted in any appropriate manner, depending on the configuration of the imaging device 105 and/or the configuration of the item 107 on the automated production line 103. In the example shown in FIG. 4, the comparison step 130 includes performing image processing on the captured image, and as such the imaging device 105 includes or is connected to a controller configured to perform the image processing on the captured image.

At step 130a, the imaging device 105 defines the search areas 121, 123, 125, 127 of the image which are to be compared to respective search areas of the validation image stored in the database 111. The search areas of the image may be determined by the controller or may be preselected depending on the configuration of the automated production station 109. For example, the automated production station 109 may be configured to apply a bead of sealant around the periphery of a component. As such, the area of interest of the image may be towards the edge of the image.

At step 130b, the imaging device 105 performs edge analysis on the captured image in order to determine the location and/or presence of assembly features of the item, such as openings and/or abutments. For example, the controller may be configured to compare areas of sharp contrast change 121a, 123a, 125a, 127a within the search areas 121, 123, 125, 127 against a set of known coordinates of features provided by one or more of the verification images stored in the database 111.

In the arrangement shown in FIG. 1, the comparison of the captured image with one or more verification images may be used to identify the items 107, 113 from a plurality of components stored in the database 111. In this manner, a component identification may be sent to the automated production station 109 such that the operation of the automated production station 109 can be adjusted depending on the type of item 107, 113 that is approaching the automated production station 109.

In the arrangement shown in FIG. 2, the comparison of the captured image with one or more verification images may be used to verify if one or more manufacturing and/or assembly operations have been performed in the required manner. For example, by performing image processing on the captured image, the location of a sealant bead that has been applied to the item 107 can be compared with the location of the sealant bead in the verification image stored in the database 111. In this manner, the comparison between the captured image and the verification image may be used to determine if the manufacturing and/or assembly operations have been performed within tolerance, i.e., to check the quality of the performed operation.

At step 130c, the imaging device 105 determines if the captured image matches the verification image. For the case where the imaging system 101 is used to identify the type of component, a positive determination results in the automated production station 109 adjusting, or maintaining, its operation so that the correct operation is performed on the component. For the case where the imaging system is used to check the quality of the operation performed by the automated production station 109 a positive determination results in the component proceeding to the next stage of manufacture and/or assembly.

The problem with the mode of operation shown in FIG. 4 is that the imaging device 105 cannot capture an image of the item 107, 113 on the production line 103 and capture a new verification image at the same time. One reason for this is that the production line 103 and an item to be introduced into the production line 103 may not be located near to each other. In order to capture a new verification image and update the database 111, the imaging device 105 is typically moved away from the production line 103, during which time the imaging device 105 is unable to capture images of items on the production line 103.

Returning back to FIGS. 1 to 3, the imaging system 101 includes a secondary imaging device 129 configured to capture one or more verification images and update the database 111 in parallel, for example at the same time as, the operation of the primary imaging device 105. In this manner, when a new type of component is introduced to the automated production line 103, the primary imaging device 105 can remain in full operation to capture images of items on the production line 103 while the secondary imaging device 129 updates the database 111. Similarly, if there is a change in the requirements of the operation performed by the automated production station 109, for example a change in the dimensions of one or more features of a component, the secondary imaging device 129 can be used to update the database 111 of verification images with the new dimensional data while the primary imaging device is operating.

In FIG. 1, the secondary imaging device 129 is configured to capture the verification images of the new component 113 to be introduced into the production line 103. For example, the new component 113 may be of a different type, size and/or shape to the item 107, and as a result the operation of an automated production station, such as the automated production station 109, may need to be adjusted to account for the changes in the item. In order to maintain the productivity of the production line 103, the secondary imaging device 129 is used to ensure that whenever a new component is introduced, verification data is uploaded to the database so that the primary imaging device 105 need not be taken offline to update the database 111.

In the arrangements shown in FIGS. 1 to 3, the primary and secondary imaging devices 105, 129 are operatively connected to the database 111. The operative connection may be by virtue of one or more wired and/or wireless connections. For example, the secondary imaging device 129 and/or the database may be located next to the automated production line 103. In this manner, the database 111 may be updated whenever a new item arrives at the site of the automated production line 103. However, the secondary imaging device 129 and/or the database may be located remote from the automated production line 103. Where an item is manufactured remote from the automated production line 103, for example, at a different part of a manufacturing facility or at a different geographical location, the verification images may be captured and/or uploaded to the database 111 from a remote location.

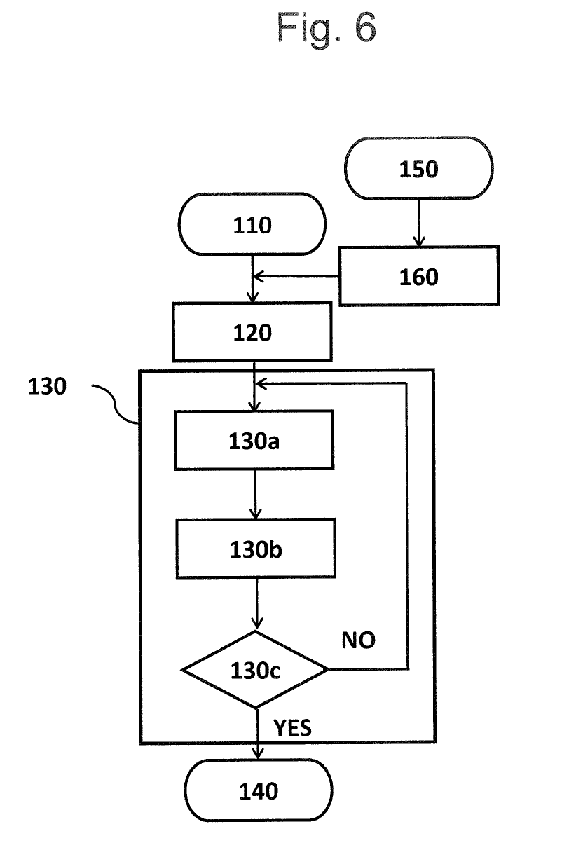

FIG. 6 shows a flow chart of a method for operating the imaging system 101 according to the present disclosure. The method comprises the step 150 of capturing one or more verification images using the secondary imaging device 129. The method further includes a step 160 of updating the database 111 before the primary imaging system 105 capture the image of the item on the production line.

While it is advantageous for the secondary imaging device 129 to operate at the same time as the primary imaging device 105, the secondary imaging device 129 may operate while the primary imaging device 105 is offline. In this manner, the secondary imaging device 129 is able to function independently from the primary imaging device 105. In one arrangement of the present disclosure, the imaging system 101 may include a plurality of primary imaging devices 105 located at different points along the automated production line 103 and/or on discrete automated production lines 103. The secondary imaging device 129 may be configured to update respective databases 111 associated with each of the plurality of primary imaging device 105. For example, the secondary imaging device 129 may be operatively connected to a central server configured to distribute the verification images to respective databases 111. Indeed, the secondary imaging device 129 itself may form a portion of an automated station configured to acquire verification images of a plurality of new items.

In another arrangement, the secondary imaging device 129 may be configured to capture the verification images of the items while the items are on the automated production line 103. For example, the secondary imaging device 129 may be located at a portion of the automated production line 103 upstream of the primary imaging device 105. In this manner, the secondary imaging device 129 is configured to capture a verification image of the new item being introduced into the production line before it arrives at the primary imaging system 105. In such a scenario, the verification image may be used to provide instructions for how to adjust the configuration of the automated production station 109 to account for the new item on the production line.

It will be appreciated by those skilled in the art that although the invention has been described by way of example with reference to one or more examples, it is not limited to the disclosed examples and that alternative examples could be constructed without departing from the scope of the invention as defined by the appended claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An imaging system comprising:
a primary imaging device configured to capture an image of an item on an automated production line and to compare the item image to one or more verification images stored in a database; and
a secondary imaging device configured to capture one or more of the verification images and to update the database in parallel with operation of the primary imaging device and the automated production line.

2. The imaging system of claim 1, wherein the secondary imaging device is remote from the automated production line.

3. The imaging system of claim 1, wherein the secondary imaging device is configured to capture a verification image of the item while the item is on the automated production line.

4. The imaging system of claim 3, wherein the secondary imaging device is provided on the automated production line at a position upstream of the primary imaging device.

5. The imaging system of claim 1, wherein the primary imaging device is configured to capture a first image of the item on the automated production line.

6. The imaging system of claim 5, wherein the primary imaging device is configured to capture the first image of the item on the automated production line before the automated production line performs an operation on the item.

7. The imaging system of claim 5, wherein the primary imaging device is configured to capture a second image of the item on the automated production line.

8. The imaging system of claim 7, wherein the primary imaging device is configured to capture a second image of the item on the automated production line after the automated production line has performed an operation on the item.

9. The imaging system of claim 7, wherein the primary imaging device includes a first camera configured to capture the first image of the item and/or the second image of the item.

10. The imaging system of claim 7, wherein the primary imaging device includes a second camera configured to capture the second image of the item.

11. An automated production line comprising:
an imaging system including:
a primary imaging device configured to capture an image of an item on an automated production line and to compare the item image to one or more verification images stored in a database; and
a secondary imaging device configured to capture one or more verification image and to update the database contemporaneously with operation of the primary imaging device and the automated production line.

12. The automated production line of claim 11, wherein the secondary imaging device is remote from the automated production line.

13. The automated production line of claim 11, wherein the secondary imaging device is configured to capture a verification image of the item while the item is on the automated production line.

14. The automated production line of claim 13, wherein the secondary imaging device is provided on the automated production line at a position upstream of the primary imaging device.

15. The imaging system of claim 11, wherein the primary imaging device is configured to capture a first image of the item on the automated production line.

16. A method of operating an imaging system comprising:
capturing an image of an item on an automated production line using a primary imaging device;
comparing the image of the item to a verification image stored in a database;
capturing one or more verification images using a secondary imaging device; and
updating the database in parallel with the operation of the primary imaging device and the automated production line.

17. The method of claim 16, wherein the capturing of the image occurs before the automated production line performs an operation on the item.

18. The method of claim 16, wherein the capturing of the one or more verification images occurs after the automated production line has performed an operation on the item.

19. The method of claim 16, wherein the secondary imaging device is remote from the automated production line.

20. The method of claim 16, wherein the secondary imaging device is provided on the automated production line at a position upstream of the primary imaging device.
